(19) United States
(12) Patent Application Publication
(10) Pub. No.: US 2016/0110394 A1
(43) Pub. Date: Apr. 21, 2016

(54) Obituary Alerting System and Method of Use

(71) Applicants: Bart Boxwell, Amarillo, TX (US); Eric Spellman, Amarillo, TX (US)

(72) Inventors: Bart Boxwell, Amarillo, TX (US); Eric Spellman, Amarillo, TX (US)

(21) Appl. No.: 14/884,761

(22) Filed: Oct. 15, 2015

Related U.S. Application Data
(60) Provisional application No. 62/064,470, filed on Oct. 15, 2014.

(51) Int. Cl. G06F 17/30

(52) U.S. Cl. CPC G06F 17/30336; G06F 17/30377; G06F 17/30876

(57) ABSTRACT

A method of using an obituary alerting system, comprising: associating a plurality of users with one another in said Obituary Alerting System 100 based on a one or more associations; indexing a one or more obituary sources; and updating a one or more living users of the deal and related information for a one or more deceased users among said plurality of users based on said one or more obituary source and said one or more associations.

### CROSS-REFERENCE TO RELATED APPLICATIONS

This application is a nonprovisional version of US Patent Application Number US patent application Ser. No. 62/064,470, filed one year ago on 2014 Oct. 15, which is hereby incorporated by reference.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

This disclosure relates generally to an obituary alerting system and method of use.

None of the known inventions and patents, taken either singularly or in combination, is seen to describe the instant disclosure as claimed. Accordingly, an improved obituary alerting system and method of use would be advantageous.

### BRIEF SUMMARY OF THE INVENTION

A method of using an obituary alerting system, comprising: associating a plurality of users with one another in said Obituary Alerting System 100 based on a one or more associations; indexing a one or more obituary sources; and updating a one or more living users of the deal and related information for a one or more deceased users among said plurality of users based on said one or more obituary source and said one or more associations.

### BRIEF DESCRIPTION OF THE SEVERAL VIEWS OF THE DRAWING

FIG. 1 illustrates a first network configuration 101 of a financial transaction system 100. In one embodiment, said Obituary Alerting System 100 can comprise a one or more computers at a one or more locations.

FIGS. 2A, 2B and 2C illustrate a perspective overview of a mobile phone 201a, a personal computer 201b and a tablet 201c.

FIGS. 3A, 3B and 3C illustrate an address space 302 within said one or more computers, an address space 302a and an address space 302d.

FIGS. 4A and 4B illustrate two embodiments for collecting and storing data with said financial transaction system 100; a first embodiment with a flow diagram between said first computer 102a and said server 108, and a second embodiment comprising of just said first computer 102a.

FIGS. 5A and 5B illustrate two examples of a flow diagram between said memory 306a and said memory 306d.

FIG. 6 illustrates database relationship view of a application database 500.

FIG. 7 illustrates user interface view of a device application 402.

FIG. 8 illustrates user interface view of a device application 402.

FIG. 9 illustrates user interface view of a device application 402.

FIG. 10 illustrates user interface view of a device application 402.

FIG. 11 illustrates user interface view of a device application 402.

FIG. 12 illustrates data table view of a user list table 602.

FIG. 13 illustrates data table view of a user index table 604.

FIG. 14 illustrates data table view of a obit index table 606.

FIG. 15 illustrates data table view of a geo list table 608.

FIG. 16 illustrates data table view of a users crt table 610.

FIG. 17 illustrates flow chart of a process 1700.

### DETAILED DESCRIPTION OF THE INVENTION

Described herein is a Obituary Alerting System and Method of Use. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

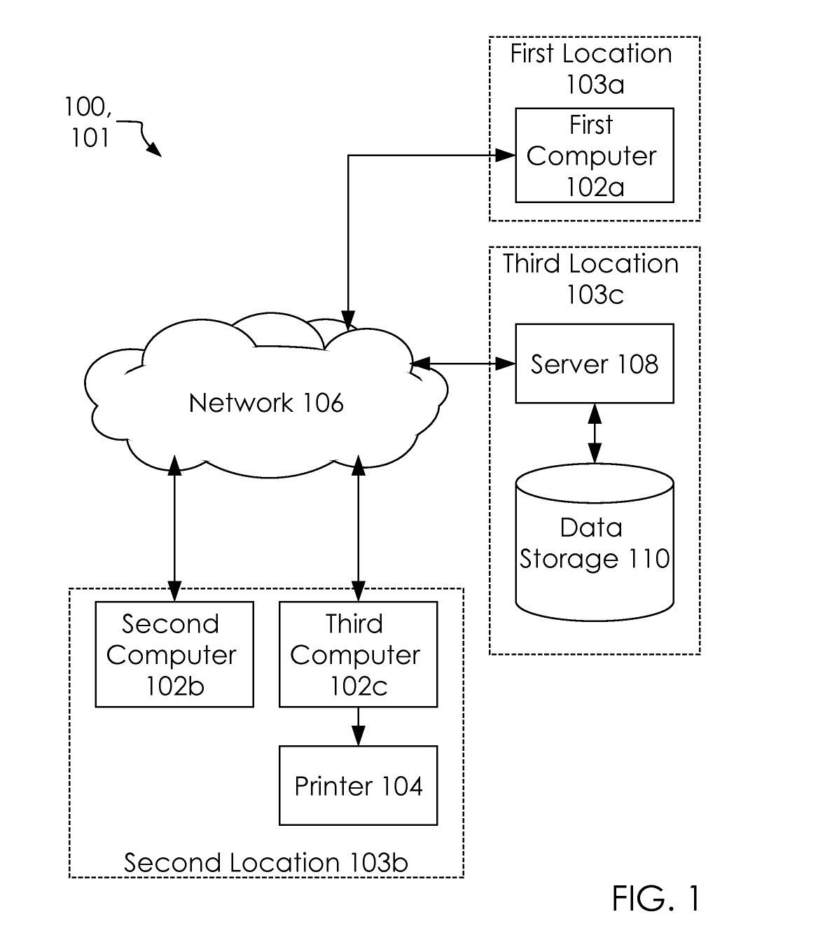

FIG. 1 illustrates a first network configuration 101 of a financial transaction system 100. In one embodiment, said Obituary Alerting System 100 can comprise a one or more computers at a one or more locations.

In one embodiment, said one or more computers can comprise a first computer 102a, a second computer 102b and a third computer 102c. In one embodiment, said one or more locations can comprise a first location 103a, a second location 103b and a third location 103c. In one embodiment, said first location can comprise a field location. In one embodiment, said one or more computers can communicate on a network 106, which can connect to a one or more servers (such as a server 108). In one embodiment, a printer 104 can be hardwired to said first computer 102a (not illustrated here), or said printer 104 can connect to one of said one or more computers (such as said third computer 102c, illustrated) via network 106.

Said network 106 can be a local area network (LAN), a wide area network (WAN), a piconet, or a combination of LANs, WANs, or piconets. One illustrative LAN is a network within a single business. One illustrative WAN is the Internet.

In one embodiment, said server 108 represents at least one, but can be many servers, each connected to said network 106. Said server 108 can connect to a data storage 110. Said data storage 110 can connect directly to said server 108, as shown in FIG. 1, or may exist remotely on said network 106. In one embodiment, said data storage 110 can comprise any suitable long-term or persistent storage device and, further, may be separate devices or the same device and may be collocated or distributed (interconnected via any suitable communications network).

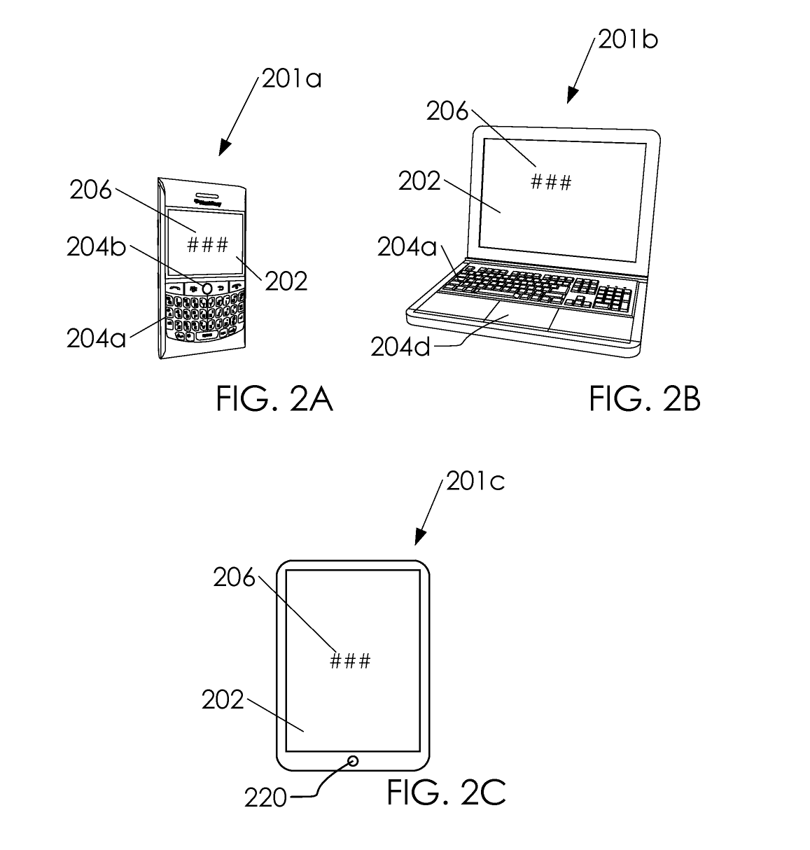

FIGS. 2A, 2B and 2C illustrate a perspective overview of a mobile phone 201a, a personal computer 201b and a tablet 201c.

In the last several years, the useful definition of a computer has become more broadly understood to include mobile phones, tablet computers, laptops, desktops, and similar. For example, Microsoft®, have attempted to merge devices such as a tablet computer and a laptop computer with the release of “Windows® 8”. In one embodiment, said one or more computers each can include, but is not limited to, a laptop (such as said personal computer 201b), desktop, workstation, server, mainframe, terminal, a tablet (such as said tablet 201c), a phone (such as said mobile phone 201a), and/or similar. Despite different form-factors, said one or more computers can have similar basic hardware, such as a screen 202 and a one or more input devices (such as a keyboard 204a, a trackball 204b, a one or more cameras 204c, a wireless—such as RFID—reader, a track pad 204d, and/or a home button 220). In one embodiment, said screen 202 can comprise a touch screen. In one embodiment, said track pad 204d can function similarly to a computer mouse as is known in the art. In one embodiment, said tablet 201c and/or said personal computer 20 lb can comprise a Microsoft® Windows® branded device, an Apple® branded device, or similar. In one embodiment, said tablet 201c can be an X86 type processor or an ARM type processor, as is known in the art.

Said Obituary Alerting System 100 can comprise a data 206. In one embodiment, said data 206 can comprise data related to financial transactions.

In one embodiment, said one or more computers can be used to input and view said data 206. In one embodiment, said data 206 can be input into said one or more computers by taking pictures with one of said one or more camera 204c, by typing in information with said keyboard 204a, or by using gestures on said screen 202 (where said screen 202 is a touch screen). Many other data entry means for devices similar to said one or more computers are well known and herein also possible with data 206. In one embodiment, said first computer 102a can comprise an iPhone®, a BlackBerry®, a smartphone, or similar. In one embodiment, one or more computers can comprise a laptop computer, a desktop computer, or similar.

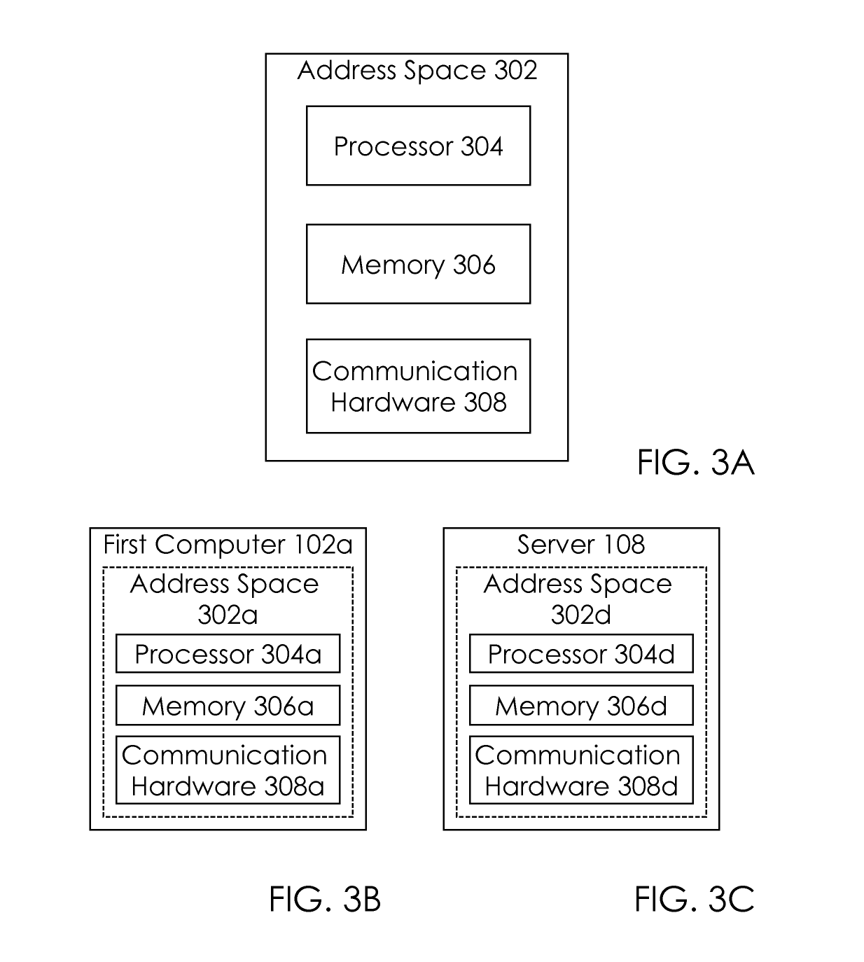

FIGS. 3A, 3B and 3C illustrate an address space 302 within said one or more computers, an address space 302a and an address space 302d.

Each among said one or more computers and said server 108 can comprise an embodiment of address space 302. In one embodiment, said address space 302 can comprise a processor 304, a memory 306, and a communication hardware 308. In one embodiment, said processor 304 can comprise a plurality of processors, said memory 306 can comprise a plurality of memory modules, and said communication hardware 308 can comprise a plurality of communication hardware components. In one embodiment, said data 206 can be sent to said processor 304; wherein, said processor 304 can perform processes on said data 206 according to an application stored in said memory 306, as discussed further below. Said processes can include storing said data 206 into said memory 306, verifying said data 206 conforms to a one or more preset standards, or ensuring a required set among said required data 206 has been gathered for said data management system and method. In one embodiment, said data 206 can include data which said one or more computers can populate automatically, such as a date and a time, as well as data entered manually. Once a portion of gathering data has been performed said data 206 can be sent to said communication hardware 308 for communication over said network 106. Said communication hardware 308 can include a network transport processor for packetizing data, communication ports for wired communication, or an antenna for wireless communication. In one embodiment, said data 206 can be collected in one or more computers and delivered to said server 108 through said network 106.

In one embodiment, said first computer 102a can comprise said address space 302a, a processor 304a, a memory 306a, and a communication hardware 308a. Likewise, in one embodiment, said server 108 can comprise said address space 302d, a processor 304d, a memory 306d, and a communication hardware 308d.

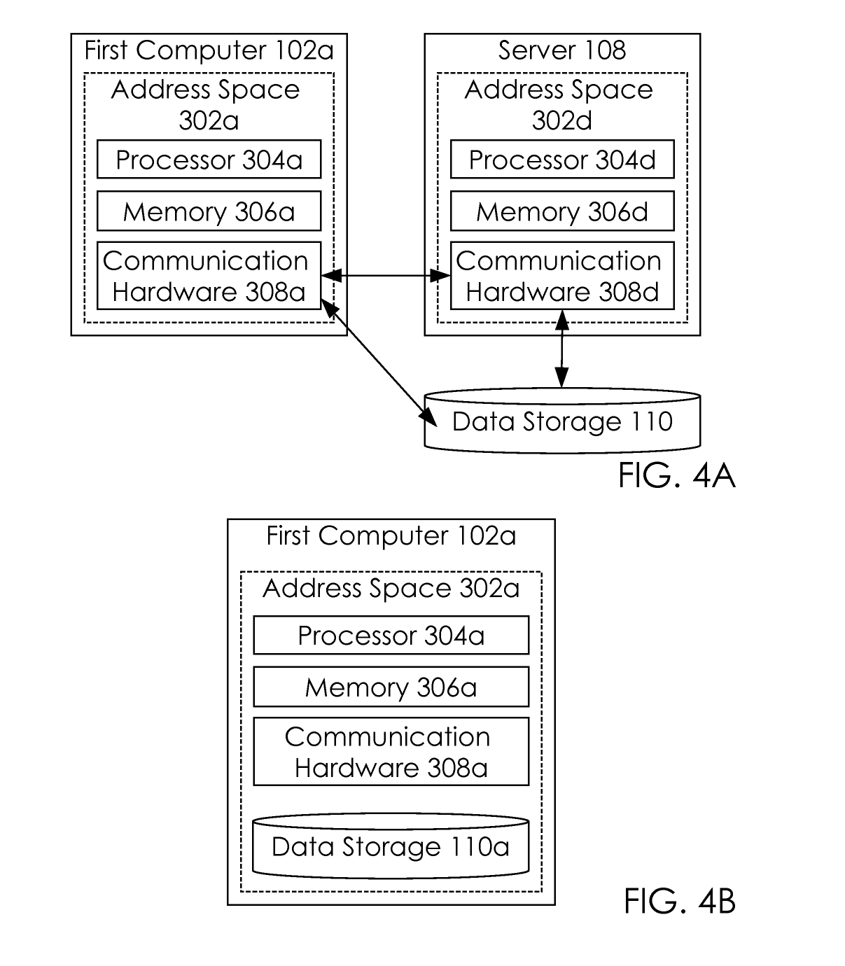

FIGS. 4A and 4B illustrate two embodiments for collecting and storing data with said financial transaction system 100; a first embodiment with a flow diagram between said first computer 102a and said server 108, and a second embodiment comprising of just said first computer 102a.

In the first embodiment, said communication hardware 308a and said communication hardware 308d can send and receive data to and from one another and or can communicate with said data storage 110 across said network 106. Likewise, in the second embodiment, data storage 110 can be embedded inside of said one or more computers as a data storage 110a, which may speed up data communications by said financial transaction system 100. In another embodiment, said data can be stored temporarily on said data storage 110a and later moved to said data storage 110 for backup and sharing purposes.

As illustrated in FIG. 4A, in one embodiment, said server 108 can comprise a third party data storage and hosting provider or privately managed as well.

As illustrated in FIG. 4B, said data storage 110 can be located on said first computer 102a, here labeled as said data storage 110a. Thus, said first computer 102a can operate without a data connection out to said server 108 while performing said system and method for field capture of data.

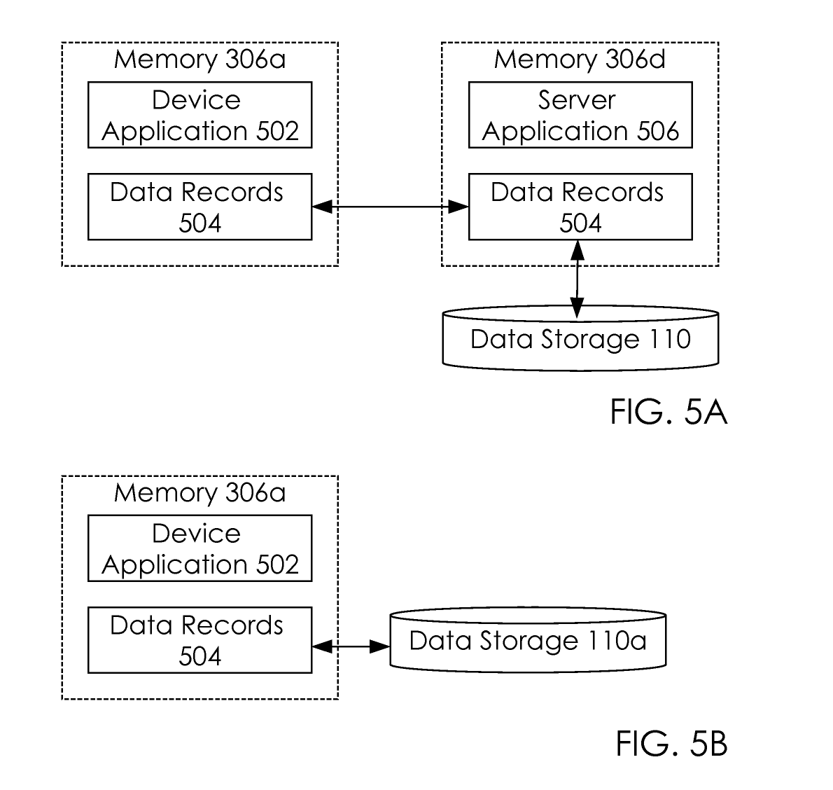

FIGS. 5A and 5B illustrate two examples of a flow diagram between said memory 306a and said memory 306d.

As illustrated in FIG. 5A, in one embodiment, said Obituary Alerting System 100 can process said data 206 on said first computer 102a and/or said server 108. For example, in one embodiment, said memory 306a can comprise a device application 502 capable of generating a data records 504 from user inputs or, otherwise, processing said data records 504 delivered to said device application 502 from said data storage 110. In one embodiment, said data records 504 can be transferred between said device application 502 on said memory 306 an of said first computer 102a and a server application 506 in said memory 306d of said server 108. In one embodiment, said server 108 can be useful for processing said data 206, as is known in the art. As illustrated in FIG. 5B, in another embodiment, said server 108 can be removed from the flow diagram entirely as said memory 306a is capable of processing said data records 504 and/or said data 206 without the assistance of said server 108.

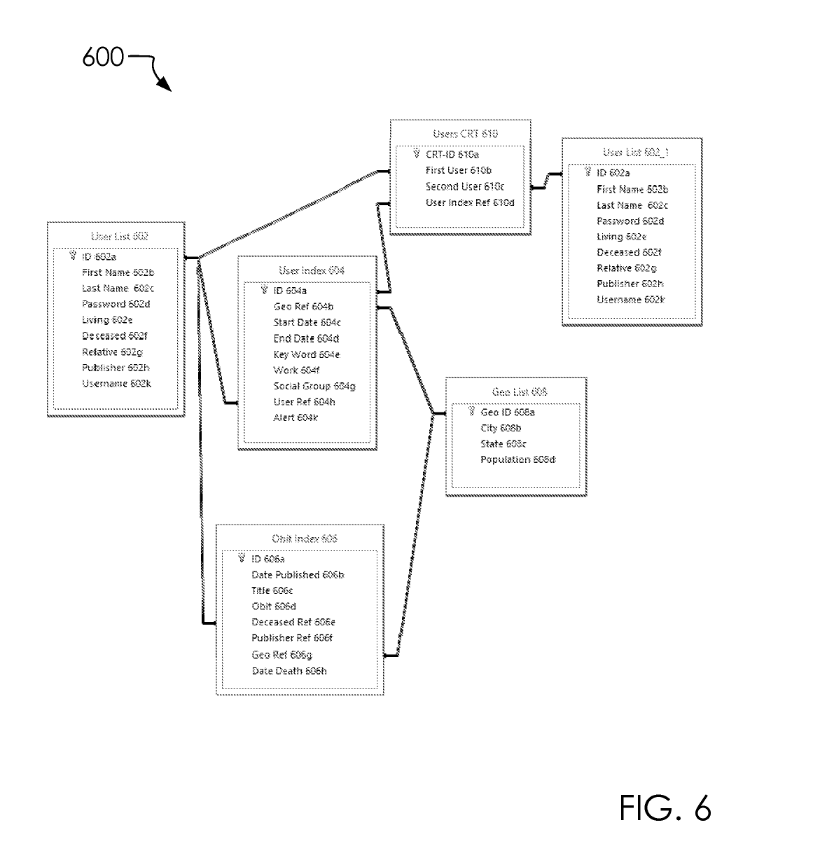

FIG. 6 illustrates database relationship view of a application database 500.

Illustrated herein are an application database 600, an user list table 602, an ID 602a, a first name 602b, a last name 602c, a password 602d, a living 602e, a deceased 602f, a relative 602g, a publisher 602h, an username 602k, an user index table 604, an ID 604a, a geo ref 604b, a start date 604c, an end date 604d, a key word 604e, a work 604f, a social group 604g, an user ref 604h, an alert 604k, an obit index table 606, an ID 606a, a date published 606b, a title 606c, an obit 606d, a deceased ref 606e, a publisher ref 606f, a geo ref 606g, a date death 606h, a geo list table 608, a geo ID 608a, a city 608b, a state 608c, a population 608d, an users crt table 610, a CRT-ID 610a, a first user 610b, a second user 610c, an user index ref 610d.

In one embodiment, said application database 600 can comprise said user list table 602, said user index table 604, said obit index table 606, said geo list table 608, said users crt table 610. In one embodiment, said user list table 602 can comprise said ID 602a, said first name 602b, said last name 602c, said password 602d, said living 602e, said deceased 602f, said relative 602g, said publisher 602h, said username 602k. In one embodiment, said user index table 604 can comprise said ID 604a, said geo ref 604b, said start date 604c, said end date 604d, said key word 604e, said work 604f, said social group 604g, said user ref 604h, said alert 604k. In one embodiment, said obit index table 606 can comprise said ID 606a, said date published 606b, said title 606c, said obit 606d, said deceased ref 606e, said publisher ref 606f, said geo ref 606g, said date death 606h. In one embodiment, said geo list table 608 can comprise said geo ID 608a, said city 608b, said state 608c, said population 608d. In one embodiment, said users crt table 610 can comprise said CRT-ID 610a, said first user 610b, said second user 610c, said user index ref 610d.

In one embodiment, said application database 600 can comprise an example of a set of tables to be used to administrate said device application 402. In one embodiment, said user list table 602 can be shown in multiple places in this view as it is referenced by more than one table among said 500/, as is known in the art.

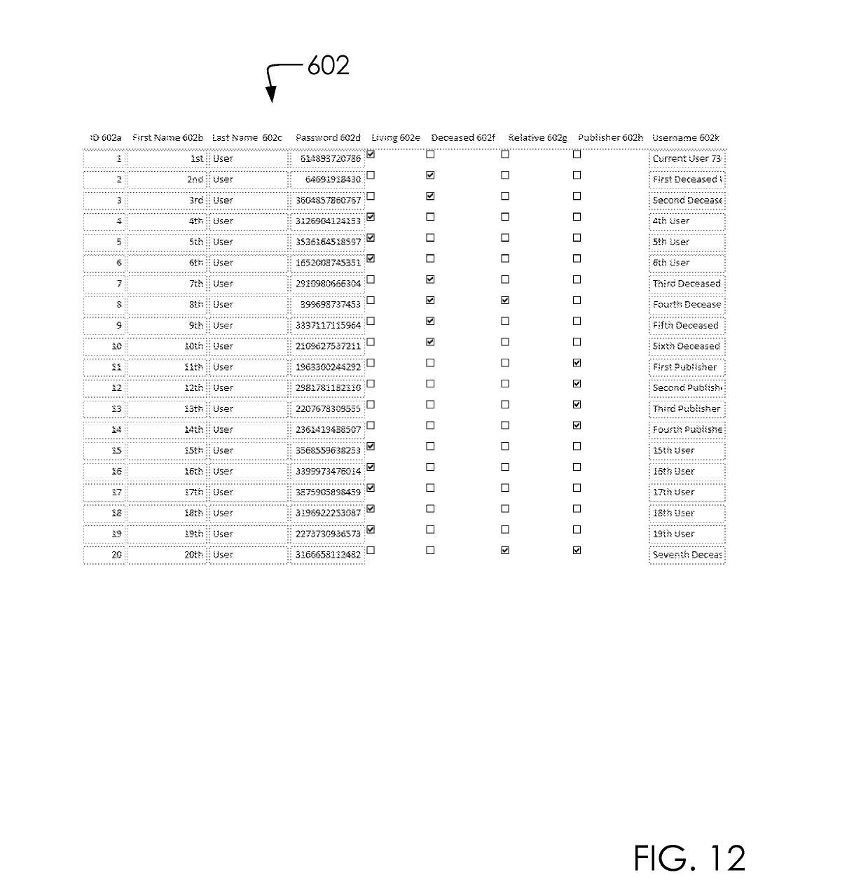

Functionality of each table can be ascertained as described to come and as is known in the art. Details of the individual fields within each table can be found in the descriptions of FIG. 12 and following.

In one embodiment, said user list table 602 can comprise a collection of data related to each user in said device application 402. For example, in one embodiment, each user may have an alias which can comprise a unique value comprising said username 602k. Likewise, said password 602d can be used for logging into said device application 402.

In one embodiment, said user index table 604 can comprise a collection of activities and history related to each user within said user list table 602. As discussed to come.

In one embodiment, said obit index table 606 can comprise an index of a one or more obituaries having been found by or entered into said Obituary Alerting System 100. In one embodiment, said obit index table 606 can be populated with data collected while crawling around the web or otherwise entered into said Obituary Alerting System 100 directly.

In one embodiment, said geo list table 608 can be referred to identify a location such as a city, state or similar.

In one embodiment, said Obituary Alerting System 100 can populate said users crt table 610 by comparing details realted to each among said user list table 602 with one another and finding a one or more overlapping activities. In one embodiment, such one or more overlaping activities can be characterized in said user index table 604. In one embodiment, each user in said user list table 602 can set a flag to determine the urgency and interest of an alert or activity by seting said alert 604k, as discussed to come.

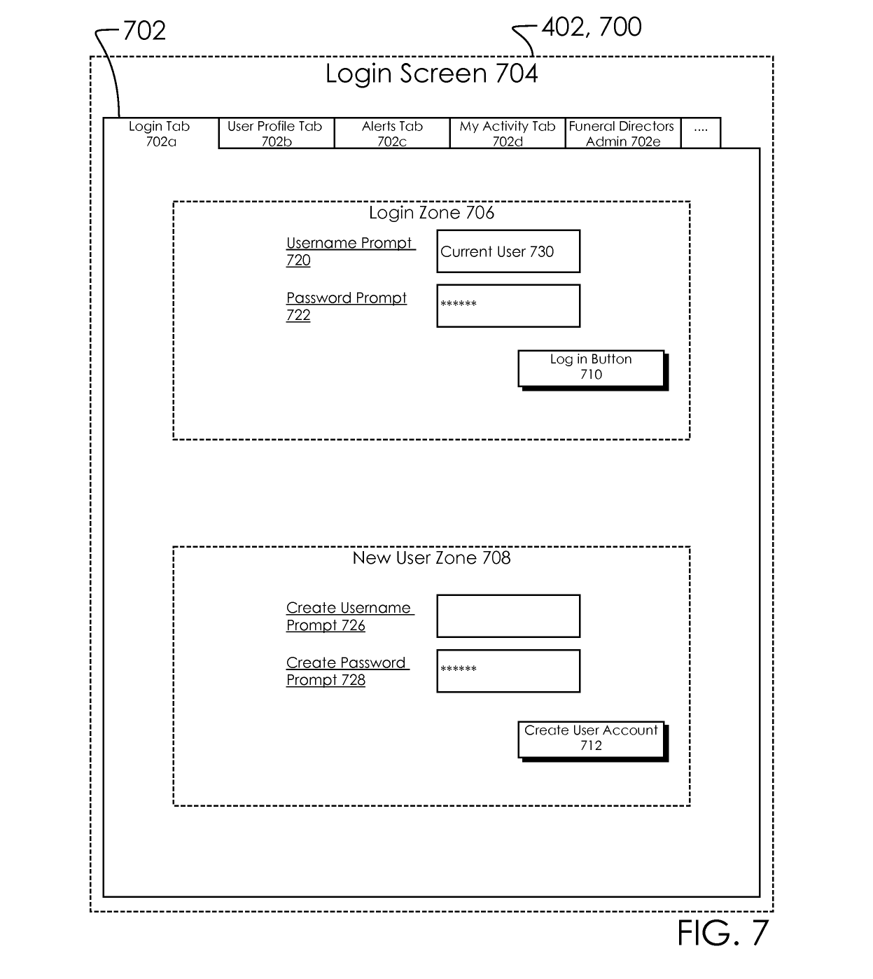

FIG. 7 illustrates user interface view of a device application 402.

Illustrated herein are an obituary alerting system user interface 700, a navigation bar 702, a login tab 702a, an user provile tab 702b, an alerts tab 702c, a my activyt tab 702d, a funeral directors admin tab 702e, a login screen 704, a login zone 706, a new user zone 708, a login button 710, a create user account button 712, an user prompt 720, a password prompt 722, a create username prompt 726, a create password prompt 728.

In one embodiment, said obituary alerting system user interface 700 can comprise said navigation bar 702, said login screen 704, said user profile screen 800, said logged in user 810. In one embodiment, said navigation bar 702 can comprise said login tab 702a, said user provile tab 702b, said alerts tab 702c, said my activyt tab 702d, said funeral directors admin tab 702e. In one embodiment, said login screen 704 can comprise said login zone 706, said new user zone 708. In one embodiment, said login zone 706 can comprise said login button 710, said user prompt 720, said password prompt 722. In one embodiment, said new user zone 708 can comprise said create user account button 712, said create username prompt 726, said create password prompt 728.

In one embodiment, said login screen 704 can be used for accessing contents within said Obituary Alerting System 100, as is known in the art.

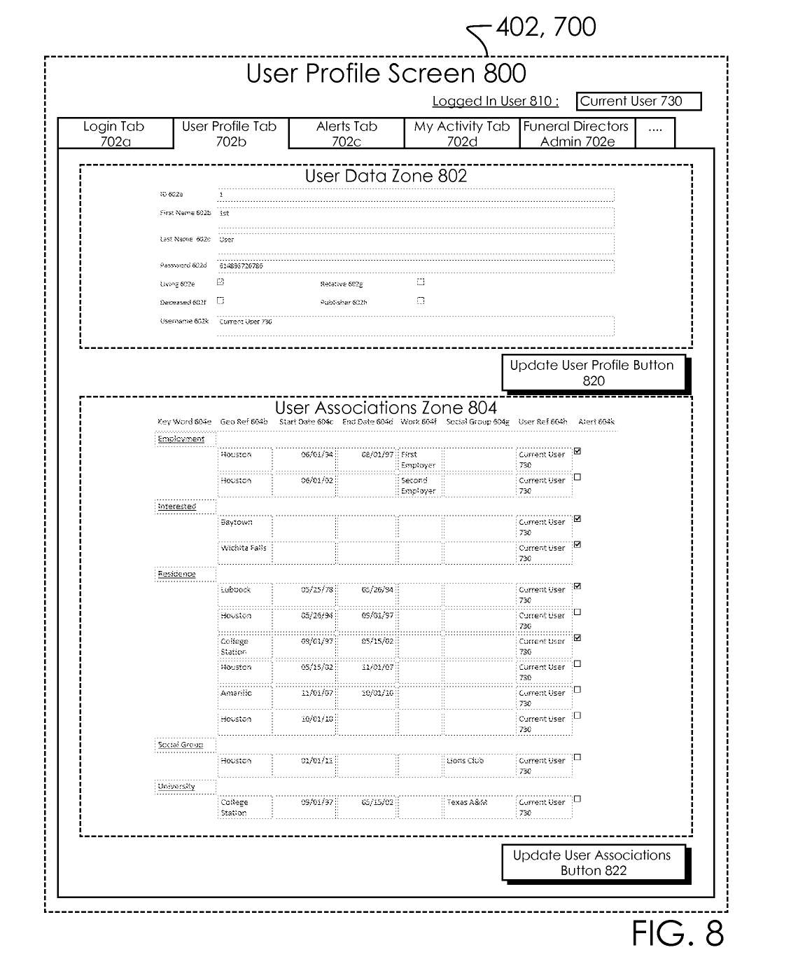

FIG. 8 illustrates user interface view of a device application 402.

Illustrated herein are an user profile screen 800, an user data zone 802, an user associations zone 804, a logged in user 810, an update user profile button 820, an update user associations button 822 822.

In one embodiment, said user profile screen 800 can comprise said user data zone 802, said user associations zone 804. In one embodiment, said user data zone 802 can comprise said update user profile button 820. In one embodiment, said user associations zone 804 can comprise said update user associations button 822 822.

In one embodiment, said 730/can arrive at said user profile screen 800 after logging into said Obituary Alerting System 100 at said login tab 702a. In one embodiment, said user profile screen 800 can comprise said user data zone 802 with said update user profile button 820, used for updating data related to said 730/.

In one embodiment, said user associations zone 804 with said update user associations button 822 822 can be used for reviewing associations related to said 730/. For example, in one embodiment, said 730/can have two prior employers in said Obituary Alerting System 100 including a ““First Employer”” and a ““Second Employer””, as illustrated; wherein, dates, locations and an alert flag can be set to determine whether said 730/wishes to receive updates related to these periods of his or her life.

Likewise, in one embodiment, said key word 604e can illustrate different portions of a user's life which can be categorized within said Obituary Alerting System 100, including employement, interested locations, residences, social groups, universities, churches (not illustrated here), and similar. In fact, said 730/can set up a variety of associations here and receive data from those associations in the future. In one embodiment, said “”Interested“” cagetgory for said key word 604e can comprise associations which said 730/is interested in but has not resided in or participated in at any time. Thus, said 730/can receive updates from all kinds of interests form said Obituary Alerting System 100.

In one embodiment, said update user profile button 820 and said update user associations button 822 822 can operate as known in the art.

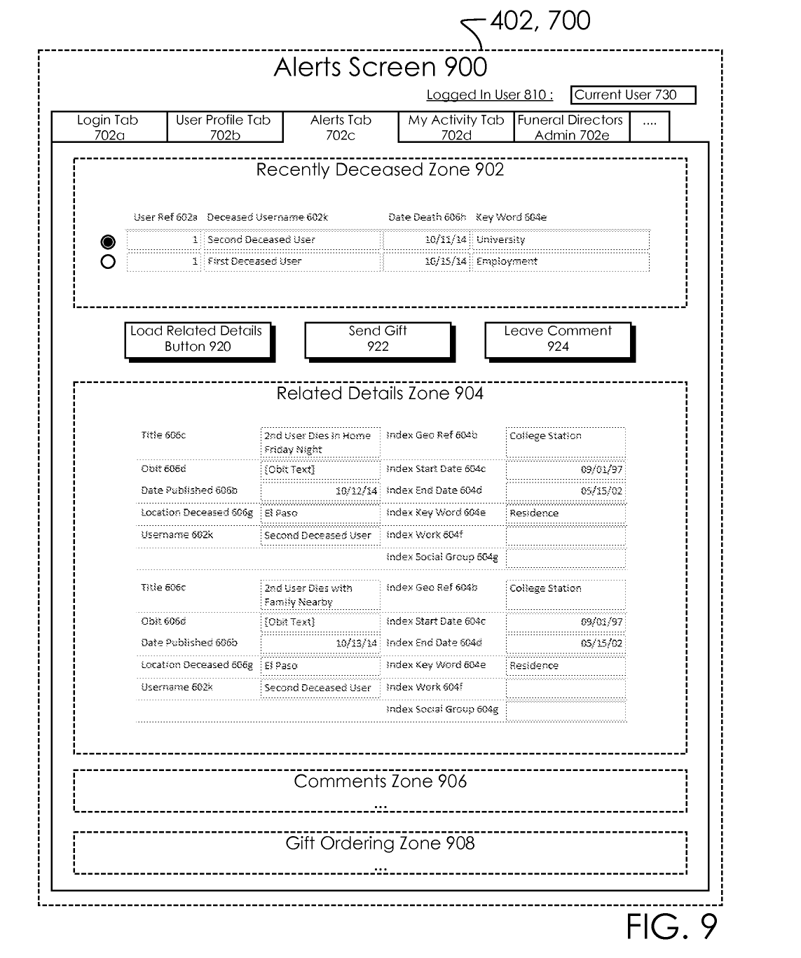

FIG. 9 illustrates user interface view of a device application 402.

Illustrated herein are an alerts screen 900, a recently deceased zone 902, a related details zone 904, a comments zone 906, a gift ordering zone 908, a load related details button 920, a send gift button 922, a leave comment button 924.

In one embodiment, said alerts screen 900 can comprise said recently deceased zone 902, said related details zone 904, said comments zone 906, said gift ordering zone 908. In one embodiment, said recently deceased zone 902 can comprise said load related details button 920, said send gift button 922, said leave comment button 924.

In one embodiment, said alerts screen 900 can be a set of alerts related to recently deceased persons which are populated into said recently deceased zone 902. In one embodiment, a list of persons being of interest to said 730/can comprise those with common associations having been manually set in said user associations zone 804 or otherwise anticipated by said Obituary Alerting System 100 with artificial intelligence, educated guessing, or similar, as is known in the art.

In one embodiment, said 730/can select one among a one or more records in said recently deceased zone 902, and then press either said load related details button 920, said send gift button 922 and/or said leave comment button 924. In one embodiment, said load related details button 920 can load more details realted to a record into said related details zone 904. In one embodiment, said send gift button 922 can launch a gift giving dialog to be delivered to a service for a deceased party, such as said gift ordering zone 908, and known in the art. In one embodiment, said leave comment button 924 can load a comments entry area, such as said comments zone 906.

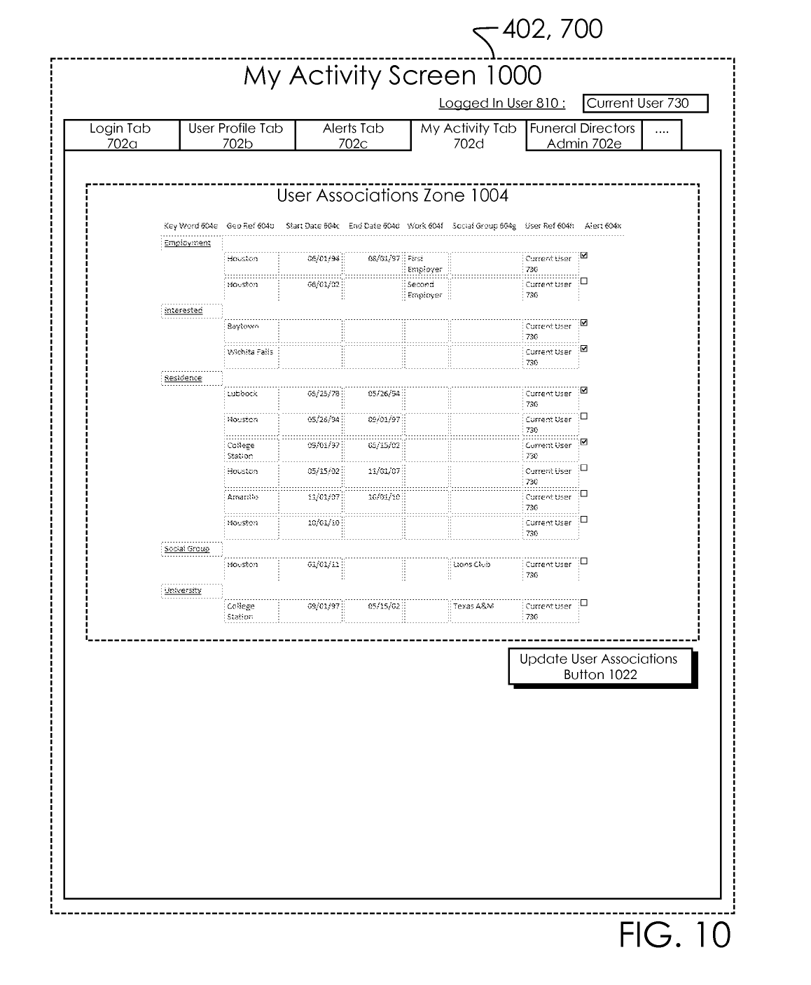

FIG. 10 illustrates user interface view of a device application 402.

Illustrated herein are a my activity screen 1000, an user associations zone 1004, an update user asscoiations button 1022.

In one embodiment, said my activity screen 1000 can comprise said user associations zone 1004. In one embodiment, said user associations zone 1004 can comprise said update user asscoiations button 1022.

In one embodiment, said user associations zone 1004 can display data similar to said user associations zone 804, in more or less detail, as is known in the art.

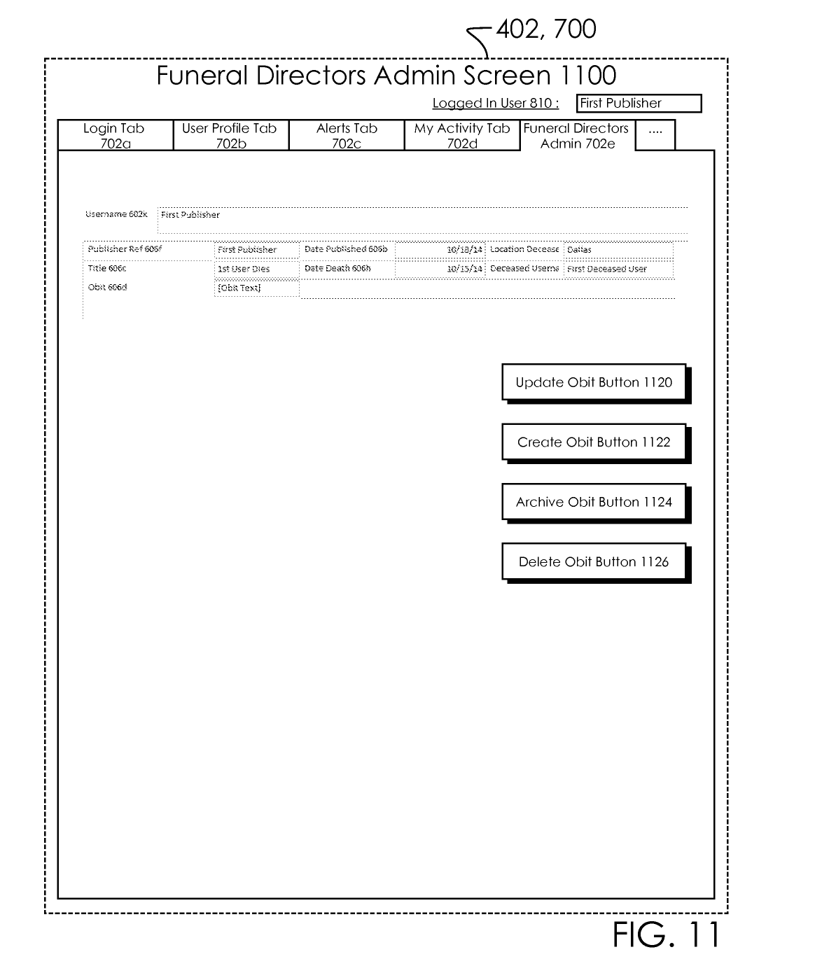

FIG. 11 illustrates user interface view of a device application 402.

Illustrated herein are a funeral directors admin screen 1100, an update obit button 1120, a create obit button 1122, an archive obit button 1124, a delete obit button 1126.

In one embodiment, said funeral directors admin screen 1100 can comprise said update obit button 1120, said create obit button 1122, said archive obit button 1124, said delete obit button 1126.

Note that said logged in user 810 no comprises a ““First Publsher”” as provided by said user list table 602.

In one embodiment, said First Publisher can comprise a one or more obituaries which need to be edited manually within said device application 402 and he can do so on said funeral directors admin screen 1100, as is known in the art.

FIG. 12 illustrates data table view of a user list table 602.

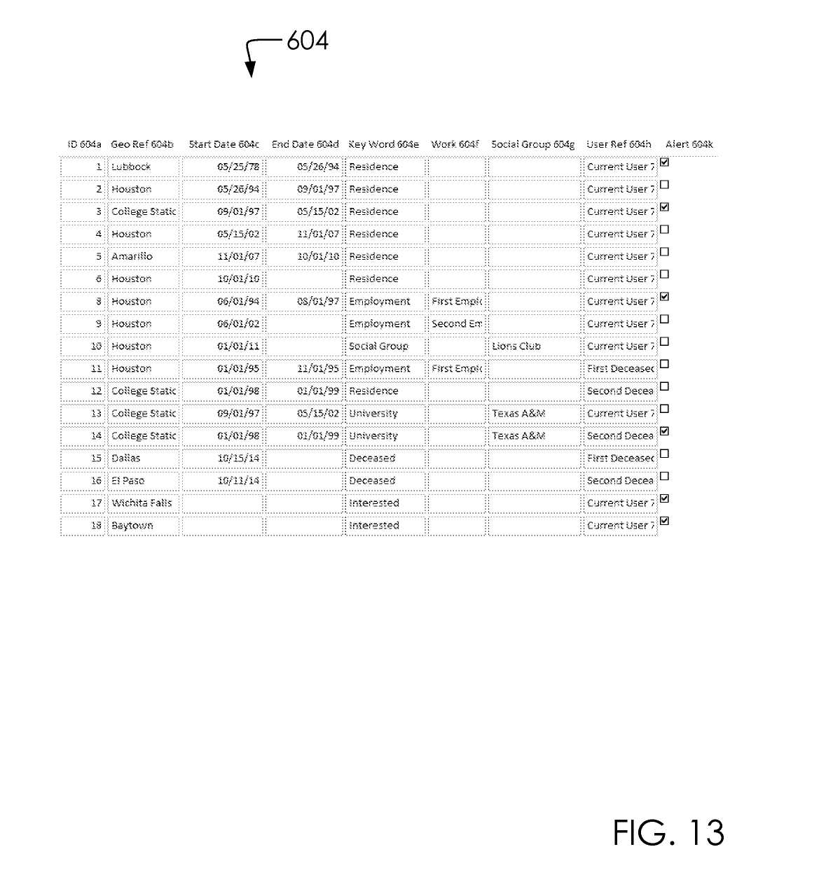

FIG. 13 illustrates data table view of a user index table 604.

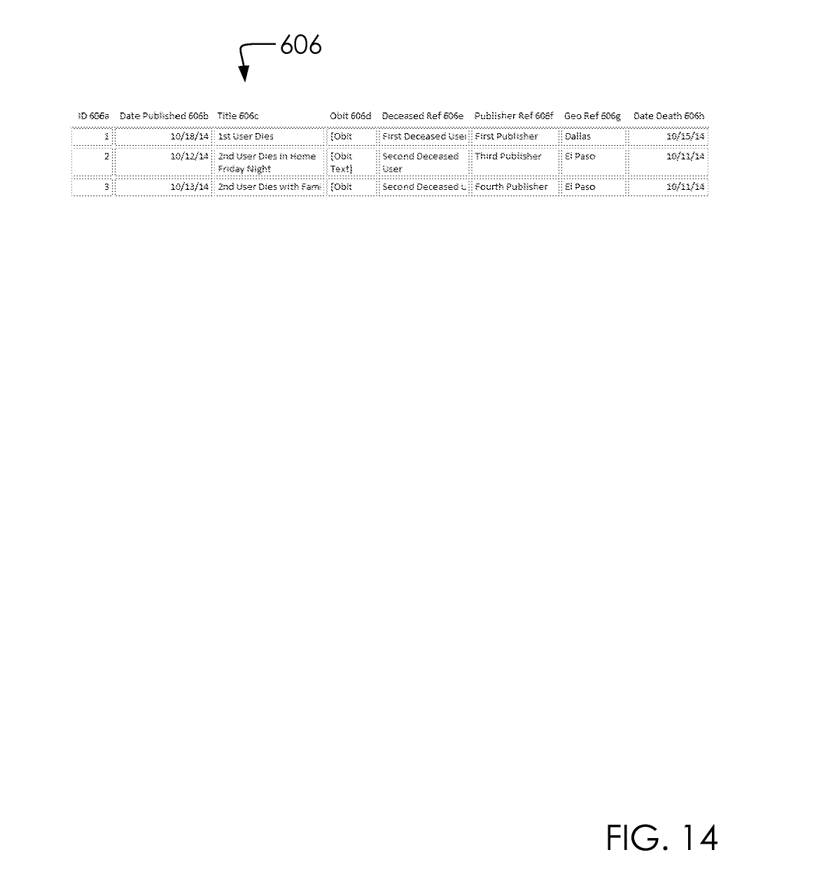

FIG. 14 illustrates data table view of a obit index table 606.

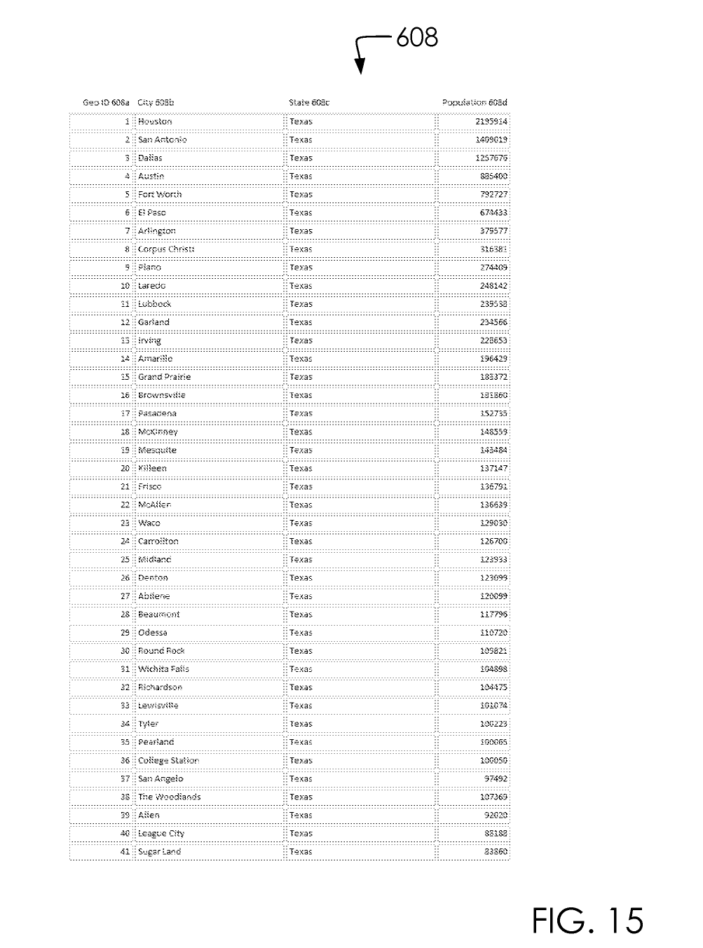

FIG. 15 illustrates data table view of a geo list table 608.

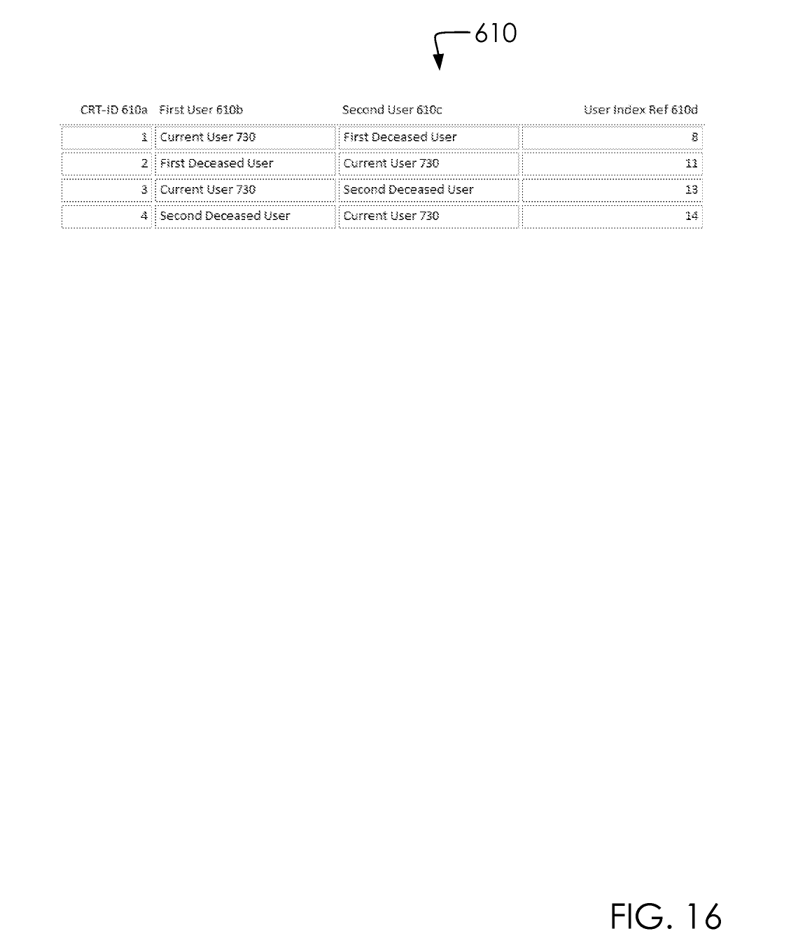

FIG. 16 illustrates data table view of a users crt table 610.

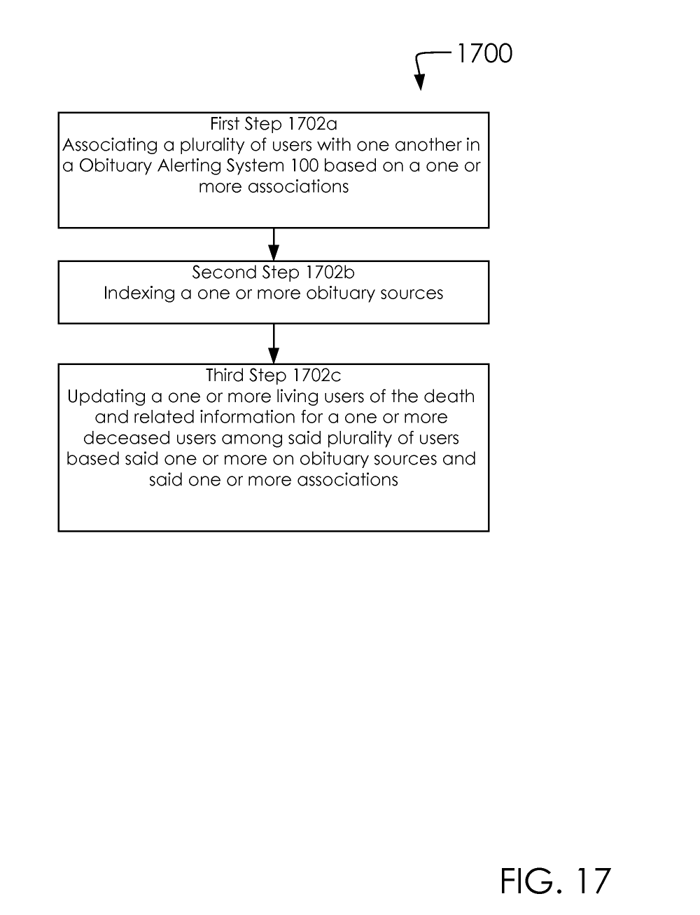

FIG. 17 illustrates flow chart of a process 1700.

Illustrated herein are a process 1700, a first step 1702a, a second step 1702b, a third step 1702c.

In one embodiment, said process 1700 can comprise said first step 1702a, said second step 1702b, said third step 1702c.

In one embodiment, said first step 1702a can comprise associating a plurality of users with one another in said Obituary Alerting System 100 based on a one or more associations; said second step 1702b can comprise indexing a one or more obituary sources; and said third step 1702c can comprise updating a one or more living users of the deal and realted information for a one or more deceased users among said pluraity of users based on said one or more obituary sourcea and said one or more associations.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.

1. A method of using an obituary alerting system, comprising:
associating a plurality of users with one another in said Obituary Alerting System 100 based on a one or more associations;
indexing a one or more obituary sources; and
updating a one or more living users of the deal and related information for a one or more deceased users among said plurality of users based on said one or more obituary source and said one or more associations.
